(19) United States
(12) Patent Application Publication
(10) Pub. No.: US 2026/0367450 A1
(43) Pub. Date: Nov. 19, 2026

(54) ELECTRONIC DEVICE

(71) Applicant: InnoLux Corporation, Miao-Li County (TW)

(72) Inventors: Yu-Chih TSENG, Miao-Li County (TW); Hong-Sheng Hsieh, Miao-Li County (TW); Chu-Hong Lai, Miao-Li County (TW); Hsu-Kuan Hsu, Miao-Li County (TW)

(73) Assignee: InnoLux Corporation, Miao-Li County (TW)

(21) Appl. No.: 19/575,939

(22) Filed: Mar. 24, 2026

Related U.S. Application Data
(60) Provisional application No. 63/776,273, filed on Mar. 24, 2025.

(30) Foreign Application Priority Data
Jan. 9, 2026 (CN) 202610028685.3

(51) Int. Cl. G02F 1/1343

(52) U.S. Cl. CPC G02F 1/13439

(57) ABSTRACT

An electronic device includes a switchable panel having adjacent first and second regions, with the second region closer to a first substrate's edge. The panel includes the first substrate, an opposing second substrate, an electrode layer, first and second conductive portions, and a dielectric layer between the electrode layer and second substrate. The electrode layer on the first substrate includes first and second electrode portions located at least partially in the first region. The first and second conductive portions, disposed in the second region, electrically connect to the first and second electrode portions, respectively. Additionally, the first electrode portion has first and second branches, and the second electrode portion has third and fourth branches, all extending along a first direction.

### CROSS REFERENCE TO RELATED APPLICATION

This application claims the benefit of U.S. Provisional Application No. 63/776,273, filed on Mar. 24th, 2025. The content of the application is incorporated herein by reference.

### BACKGROUND OF THE DISCLOSURE

### 1. Field of the Disclosure

The present disclosure relates to an electronic device, and more particularly to an electronic device that can reduce impedance or short circuits.

### 2. Description of the Prior Art

Electronic devices or tiling electronic devices have been widely used in different fields such as communication, display, automotive, or aviation. With the vigorous development of electronic devices, there is a trend toward thinner and lighter designs, which leads to higher requirements for the reliability or quality of electronic devices.

### SUMMARY OF THE DISCLOSURE

The present disclosure is directed to an electronic device that can reduce impedance or short circuits.

According to an embodiment of the present disclosure, an electronic device has a first region and a second region adjacent to the first region. The electronic device comprises a switchable panel. The switchable panel comprises a first substrate, an electrode layer, a first wire part, a second wire part, a second substrate, and a dielectric layer. The second region is closer to an edge of the first substrate than the first region. The electrode layer is disposed on a first surface of the first substrate and comprises a first electrode part and a second electrode part. At least a portion of the first electrode part is disposed in the first region, and at least a portion of the second electrode part is disposed in the first region. The first wire part is disposed in the second region and electrically connected to the first electrode part. The second wire part is disposed in the second region and electrically connected to the second electrode part. The second substrate is disposed opposite to the first surface of the first substrate. The dielectric layer is disposed between the electrode layer and the second substrate. The first electrode part comprises a first branch and a second branch extending along a first direction, and the second electrode part comprises a third branch and a fourth branch extending along the first direction.

### BRIEF DESCRIPTION OF THE DRAWINGS

FIG. 1 is an exploded schematic view of an electronic device according to an embodiment of the present disclosure.

FIG. 2 is a schematic cross-sectional view of the electronic device of FIG. 1.

FIG. 3 is a schematic top view of a switchable panel in the electronic device of FIG. 2.

FIG. 4 is an enlarged schematic view of a region R1 of the switchable panel of FIG. 3.

FIG. 5A is a schematic cross-sectional view of the region R1 of FIG. 4 along a section line I-I′.

FIG. 5B is a schematic cross-sectional view of the region R1 of FIG. 4 along a section line II-II′.

FIG. 6 is an enlarged schematic view of a region R2 of the switchable panel of FIG. 3.

FIG. 7 is an enlarged schematic view of a region R1 of a switchable panel in an electronic device according to another embodiment of the present disclosure.

FIG. 8 is an exploded schematic view of an electronic device according to another embodiment of the present disclosure.

FIG. 9 is a schematic cross-sectional view of the electronic device of FIG. 8.

### DETAILED DESCRIPTION

Although the terms “first,” “second,” “third,” etc., may be used to describe various components, these components are not limited by these terms. These terms are only used to distinguish one component from another in the specification. The same terms may not be used in the claims, and are replaced by first, second, third, etc., according to the order in which the components are recited in the claims. Therefore, a first component in the specification below may be a second component in the claims.

In the present disclosure, the electronic device may comprise a display device, a light-emitting device, a backlight device, a virtual reality device, an augmented reality (AR) device, a tiling device, or any combination thereof, but is not limited thereto. The display device can be a non-self-luminous display or a self-luminous display according to requirements, and can be a color display or a monochrome display according to requirements. The tiling device can be a display tiling device or an antenna tiling device, but is not limited thereto. Electronic units in the electronic device may comprise passive components and active components, such as capacitors, resistors, inductors, diodes, transistors, etc. The diodes may comprise light emitting diodes (LEDs) or photodiodes. The light emitting diodes may, for example, comprise organic light emitting diodes (OLEDs), mini LEDs, micro LEDs, or quantum dot LEDs, but are not limited thereto. The electronic device may also comprise fluorescent materials, phosphorescent materials, quantum dot (QD) materials, or other suitable materials according to requirements, but is not limited thereto. The electronic device may have peripheral systems such as a driving system, a control system, a light source system, etc., to support a display device, an antenna device, a wearable device (for example, including an augmented reality or virtual reality device), a vehicle-mounted device (for example, including an automobile windshield), or a tiling device. It should be noted that the electronic device may be any arrangement and combination of the foregoing, but is not limited thereto. Hereinafter, an electronic device is used as an example to describe the content of the present disclosure, but the present disclosure is not limited thereto.

It should be understood that in the following embodiments, features from several different embodiments may be replaced, recombined, or mixed to complete other embodiments without departing from the spirit of the present disclosure. Features among various embodiments can be arbitrarily mixed and matched as long as they do not contradict the spirit of the disclosure or conflict with each other.

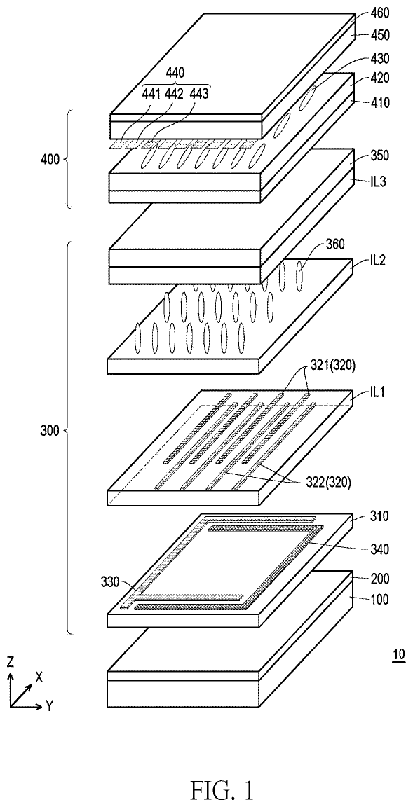

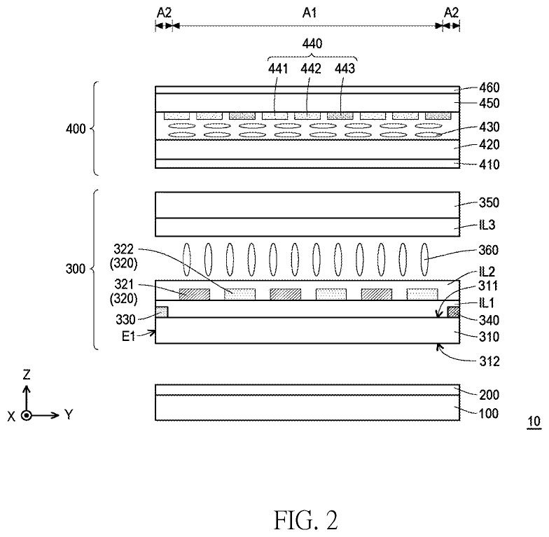

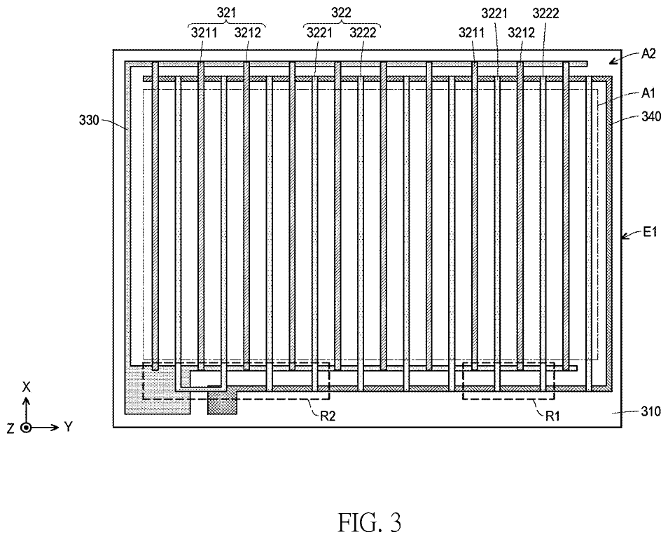

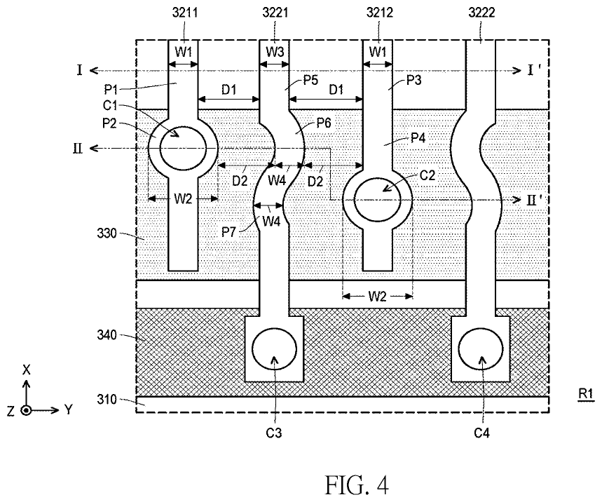

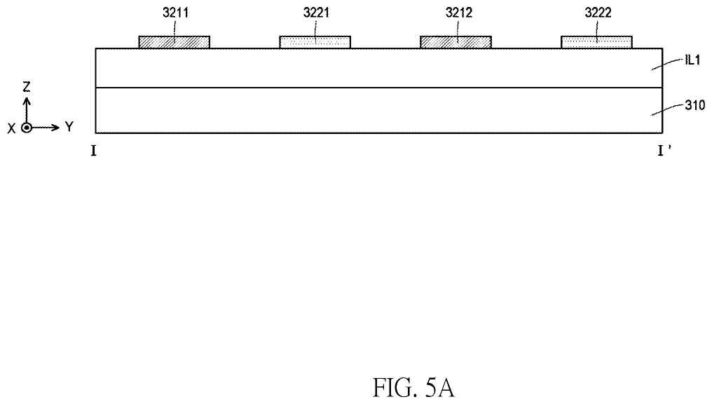

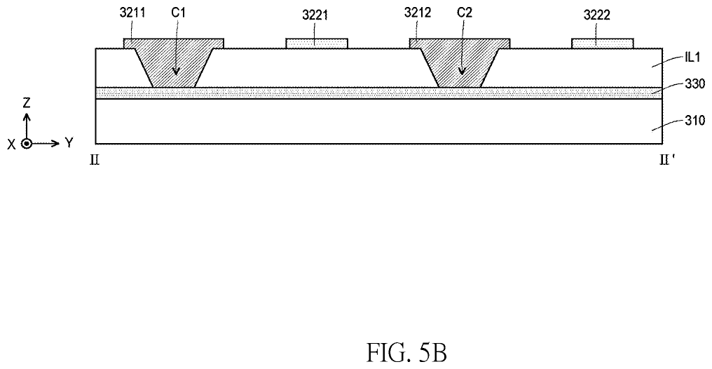

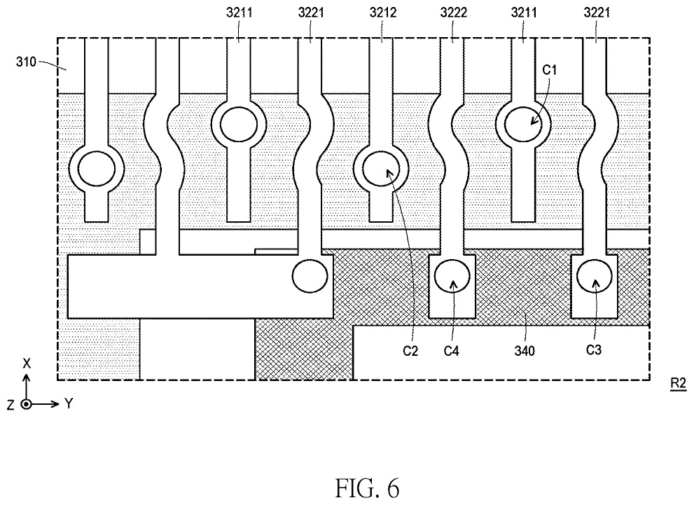

FIG. 1 is an exploded schematic view of an electronic device according to an embodiment of the present disclosure. FIG. 2 is a schematic cross-sectional view of the electronic device of FIG. 1. FIG. 3 is a schematic top view of a switchable panel in the electronic device of FIG. 2. FIG. 4 is an enlarged schematic view of a region R1 of the switchable panel of FIG. 3. FIG. 5A is a schematic cross-sectional view of the region R1 of FIG. 4 along a section line I-I′. FIG. 5B is a schematic cross-sectional view of the region R1 of FIG. 4 along a section line II-II′. FIG. 6 is an enlarged schematic view of a region R2 of the switchable panel of FIG. 3. For clarity of the drawings and ease of description, certain components of the switchable panel 300 in the electronic device 10 are omitted from FIG. 3 (for example: insulating layer IL1, insulating layer IL2, insulating layer IL3, second substrate 350, and dielectric layer 360).

Please refer to FIG. 1, FIG. 2, and FIG. 3. The electronic device 10 of the present disclosure comprises a backlight module 100, an optical module 200, a switchable panel 300, and a display panel 400. As shown in FIG. 3, the electronic device 10 has a first region A1 and a second region A2 adjacent to the first region A1. In this embodiment, the second region A2 can surround the first region A1, but is not limited thereto.

The optical module 200 is disposed on the backlight module 100. The optical module 200 may comprise at least one prism layer, but is not limited thereto. In some embodiments, the optical module may be omitted depending on design requirements.

The switchable panel 300 is disposed on the optical module 200, and the switchable panel 300 is disposed between the backlight module 100 and the display panel 400. The switchable panel 300 comprises a first substrate 310, an insulating layer IL1, an electrode layer 320, a first wire part 330, a second wire part 340, a first contact hole C1, a second contact hole C2, a third contact hole C3, a fourth contact hole C4, an insulating layer IL2, an insulating layer IL3, a second substrate 350, and a dielectric layer 360.

The first substrate 310 has a first surface 311 and a second surface 312 opposite to each other. The first surface 311 faces the display panel 400, and the second surface 312 faces the backlight module 100. As shown in FIG. 3, the second region A2 can be closer to an edge E1 of the first substrate 310 than the first region A1.

The first wire part 330 and the second wire part 340 are respectively disposed on the first surface 311 of the first substrate 310. As shown in FIG. 3, the first wire part 330 is disposed in the second region A2, and the second wire part 340 is disposed in the second region A2. The first wire part 330 and the second wire part 340 can be physically separated from each other. In some embodiments, the first wire part 330 and the second wire part 340 can be electrically separated from each other, and the first wire part 330 and the second wire part 340 transmit different signals. In this embodiment, the first wire part 330 and the second wire part 340 are opaque, and the first wire part 330 and the second wire part 340 may comprise metal or metal oxide, such as copper or other opaque conductive materials, but are not limited thereto.

The insulating layer IL1 is disposed on the first wire part 330 and the second wire part 340. The insulating layer IL1 can cover the first wire part 330 and the second wire part 340.

The electrode layer 320 is disposed on the first surface 311 of the first substrate 310 and the insulating layer IL1. The electrode layer 320 is disposed between the wire parts (i.e., the first wire part 330 and the second wire part 340) and the dielectric layer 360. In this embodiment, the electrode layer 320 is transparent, and the electrode layer 320 may comprise indium tin oxide (ITO) or other transparent conductive materials, but is not limited thereto.

The electrode layer 320 comprises a first electrode part 321 and a second electrode part 322. As shown in FIG. 3, at least a portion of the first electrode part 321 can be disposed in the first region A1, and at least a portion of the second electrode part 322 can be disposed in the first region A1. The first electrode part 321 and the second electrode part 322 can be physically separated from each other. In some embodiments, the first electrode part 321 and the second electrode part 322 can be electrically separated from each other, and the first electrode part 321 and the second electrode part 322 transmit different signals. In this embodiment, the first electrode part 321 can be electrically connected to the first wire part 330, and the second electrode part 322 can be electrically connected to the second wire part 340, so as to reduce the impedance of the first electrode part 321 and the second electrode part 322 in the first region A1 or the problem of uneven potential distribution.

Specifically, as shown in FIG. 3, the first electrode part 321 may comprise a first branch 3211 and a second branch 3212 extending along a first direction X. The second electrode part 322 may comprise a third branch 3221 and a fourth branch 3222 extending along the first direction X. In this embodiment, a first voltage (or a first signal) can be applied to the first electrode part 321, and a second voltage (or a second signal) can be applied to the second electrode part 322, and the first voltage can be different from the second voltage (or the first signal can be different from the second signal).

In this embodiment, a first direction X, a second direction Y, and a third direction Z are different directions. The first direction X and the second direction Y are extension directions of the first substrate 310. The first direction X is, for example, the vertical direction in FIG. 3, the second direction Y is, for example, the horizontal direction in FIG. 3, and the third direction Z is, for example, a normal direction of the first substrate 310. Wherein, the first direction X can be substantially perpendicular to the second direction Y, and the first direction X and the second direction Y can be substantially perpendicular to the third direction Z, respectively, but are not limited thereto.

Please refer to FIG. 4, FIG. 5A, FIG. 5B, and FIG. 6. The first contact hole C1, the second contact hole C2, the third contact hole C3, and the fourth contact hole C4 can respectively extend through the insulating layer IL1. Opposite sides of the first contact hole C1 can respectively contact the first branch 3211 of the first electrode part 321 and the first wire part 330. Opposite sides of the second contact hole C2 can respectively contact the second branch 3212 of the first electrode part 321 and the first wire part 330. Opposite sides of the third contact hole C3 can respectively contact the third branch 3221 of the second electrode part 322 and the second wire part 340. Opposite sides of the fourth contact hole C4 can respectively contact the fourth branch 3222 of the second electrode part 322 and the second wire part 340. That is, the first branch 3211 can be electrically connected to the first wire part 330 via the first contact hole C1, the second branch 3212 can be electrically connected to the first wire part 330 via the second contact hole C2, the third branch 3221 can be electrically connected to the second wire part 340 via the third contact hole C3, and the fourth branch 3222 can be electrically connected to the second wire part 340 via the fourth contact hole C4. Furthermore, as shown in FIG. 4 and FIG. 6, the shapes of the first contact hole C1, the second contact hole C2, the third contact hole C3, and the fourth contact hole C4 can be circular, but are not limited thereto. In some embodiments, the shapes of the first contact hole C1, the second contact hole C2, the third contact hole C3, and the fourth contact hole C4 can be rectangular (not shown).

Please refer to FIG. 4 and FIG. 6. In the second direction Y, the first contact hole C1 can be misaligned with the second contact hole C2, and the first contact hole C1 is not overlapped with the second contact hole C2, thereby reducing the risk of a short circuit between the adjacent first branch 3211 and third branch 3221 (or between the adjacent second branch 3212 and third branch 3221) due to being too close. In the second direction Y, the third contact hole C3 can be at least partially overlapped with the fourth contact hole C4. In addition, in the first direction X, neither the first contact hole C1 nor the second contact hole C2 is overlapped with the third contact hole C3 and the fourth contact hole C4.

Please refer to FIG. 4 and FIG. 6. The first branch 3211 may comprise a connected first part P1 and second part P2; wherein, in the third direction Z, the first part P1 is not overlapped with the first wire part 330, and the second part P2 can be overlapped with the first wire part 330. The second branch 3212 may comprise a connected third part P3 and fourth part P4; wherein, in the third direction Z, the third part P3 is not overlapped with the first wire part 330, and the fourth part P4 can be overlapped with the first wire part 330. The third branch 3221 may comprise a connected fifth part P5, sixth part P6, and seventh part P7, and the sixth part P6 is disposed between the fifth part P5 and the seventh part P7; wherein, in the third direction Z, the fifth part P5 is not overlapped with the first wire part 330, and the sixth part P6 and the seventh part P7 can be overlapped with the first wire part 330.

Please refer to FIG. 4 and FIG. 6. In the second direction Y, the sixth part P6 can be overlapped with the first contact hole C1, and the seventh part P7 can be overlapped with the second contact hole C2. Furthermore, in the second direction Y, the sixth part P6 can be bent toward the fourth part P4 to have a curved shape, the seventh part P7 can be bent toward the second part P2 to have a curved shape, and a bending direction of the sixth part P6 can be substantially opposite to a bending direction of the seventh part P7, thereby reducing the risk of a short circuit between the adjacent first branch 3211 and third branch 3221 (or between the adjacent second branch 3212 and third branch 3221) due to being too close. That is, a portion of the third branch 3221 not overlapped with the first wire part 330 (i.e., the fifth part P5) can have a straight shape, and another portion of the third branch 3221 overlapped with the first wire part 330 (i.e., the sixth part P6 and the seventh part P7) can have a curved shape. In addition, a portion of the fourth branch 3222 not overlapped with the first wire part 330 can also have a straight shape, and another portion of the fourth branch 3222 overlapped with the first wire part 330 can also have a curved shape.

Please refer to FIG. 4 and FIG. 6. In the second direction Y, the first part P1 and the third part P3 have a maximum width W1, and the second part P2 and the fourth part P4 have a maximum width W2. In this embodiment, the maximum width W1 can be less than the maximum width W2, and both the maximum width W1 and the maximum width W2 can be less than 10 micrometers (μm) and greater than 1 micrometer (i.e., 1 μm≤W1≤W2≤10 μm), but are not limited thereto.

Please refer to FIG. 4 and FIG. 6. In the second direction Y, the fifth part P5 has a width W3, and the sixth part P6 and the seventh part P7 have a width W4. In this embodiment, the width W3 is substantially equal to the width W4, and the width W3 and the width W4 can be less than 10 micrometers and greater than 1 micrometer (i.e., W3=W4, 1 μm≤W3(W4)≤10 μm), but are not limited thereto.

Please refer to FIG. 4 and FIG. 6. In the second direction Y, there is a minimum distance D1 between the first part P1 and the fifth part P5 (or between the third part P3 and the fifth part P5), a minimum distance D2 between the second part P2 and the sixth part P6 (or between the fourth part P4 and the sixth part P6), and a minimum distance D2 between the second part P2 and the seventh part P7 (or between the fourth part P4 and the seventh part P7). In this embodiment, the minimum distance D2 can be less than the minimum distance D1, and both the minimum distance D1 and the minimum distance D2 can be less than 5 micrometers and greater than 1 micrometer (i.e., 1 μm≤D2≤D1≤10 μm), thereby reducing a spacing between the adjacent first branch 3211 and third branch 3221 (or between the adjacent second branch 3212 and third branch 3221), and reducing the risk of a short circuit caused by them being too close, but it is not limited thereto.

For example, in this embodiment, the maximum width W1 can be, for example, 4 micrometers, the maximum width W2 can be, for example, 8 micrometers, the width W3 can be, for example, 4 micrometers, the width W4 can be, for example, 4 micrometers, the minimum distance D1 can be, for example, 4 micrometers, and the minimum distance D2 can be, for example, 3 micrometers, but is not limited thereto.

Please refer to FIG. 1 and FIG. 2. The insulating layer IL2 is disposed on the electrode layer 320, and the insulating layer IL2 can cover the electrode layer 320.

The dielectric layer 360 is disposed on the insulating layer IL2, and the dielectric layer 360 is disposed between the electrode layer 320 and the second substrate 350. In this embodiment, the dielectric layer 360 can be liquid crystal, but is not limited thereto.

The insulating layer IL3 is disposed on the dielectric layer 360, and the insulating layer IL3 is disposed between the dielectric layer 360 and the second substrate 350.

The second substrate 350 is disposed on the insulating layer IL2, and the second substrate 350 can be disposed opposite to the first surface 311 of the first substrate 310.

The display panel 400 is disposed on the switchable panel 300. In the third direction Z, the display panel 400 can be at least partially overlapped with the switchable panel 300. The display panel 400 may comprise an insulating layer 410, a substrate 420, a dielectric layer 430, a color filter layer 440, a substrate 450, and an insulating layer 460. The substrate 420 is disposed on the insulating layer 410, the dielectric layer 430 is disposed on the substrate 420, the color filter layer 440 is disposed on the dielectric layer 430, the substrate 450 is disposed on the color filter layer 440, and the insulating layer 460 is disposed on the substrate 450. Wherein, the dielectric layer 430 is disposed between the substrate 420 and the substrate 450, and the color filter layer 440 is disposed between the dielectric layer 430 and the substrate 450. In this embodiment, the dielectric layer 430 can be liquid crystal, but is not limited thereto. The color filter layer 440 may comprise a red filter layer 441, a green filter layer 442, and a blue filter layer 443, but is not limited thereto.

In this embodiment, by applying or not applying a voltage, an arrangement of the dielectric layer 360 in the switchable panel 300 can be changed, so that a traveling direction of light from the backlight module 100 passing through the switchable panel 300 can be changed, thereby enabling an image displayed by the electronic device 10 to have a privacy or sharing effect.

In this embodiment, a material of the first substrate 310, the second substrate 350, the substrate 420, and the substrate 450 may comprise glass, quartz, sapphire, ceramic, polycarbonate (PC), polyimide (PI), polyethylene terephthalate (PET), other suitable materials, or a combination of the foregoing, but is not limited thereto.

In this embodiment, the insulating layer IL1, the insulating layer IL2, the insulating layer IL3, the insulating layer 410, and the insulating layer 460 can be a single-layer structure or a multi-layer structure, and may comprise organic materials, inorganic materials, or a combination of the foregoing, but is not limited thereto.

Other embodiments are listed below for illustration. It must be stated here that the following embodiments adopt the element labels and part of the content of the foregoing embodiments, wherein the same labels are used to denote the same or similar elements, and the description of the same technical content is omitted. For the description of the omitted parts, reference can be made to the foregoing embodiments, and will not be repeated in the following embodiments.

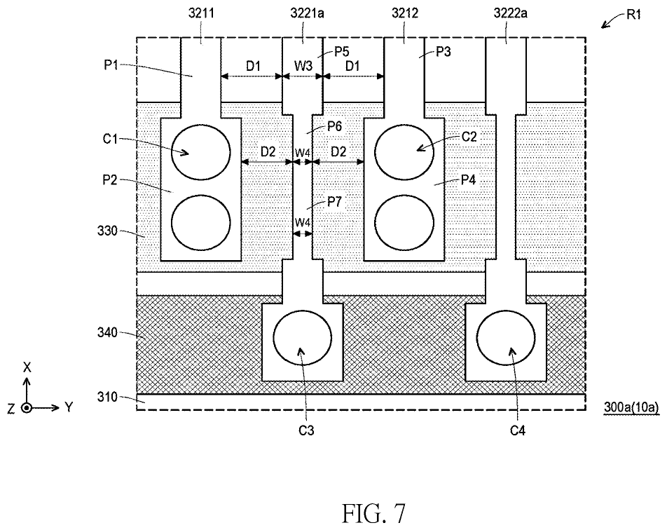

FIG. 7 is an enlarged schematic view of a region R1 of a switchable panel in an electronic device according to another embodiment of the present disclosure. Please refer to FIG. 7 and FIG. 4 simultaneously. The electronic device 10a of this embodiment is similar to the electronic device 10 of FIG. 4, with the difference being that: in the switchable panel 300a of the electronic device 10a of this embodiment, the sixth part P6 and the seventh part P7 of the third branch 3221a are not bent and do not have a curved shape, and another portion of the fourth branch 3222a overlapped with the first wire part 330 also does not have a curved shape.

Specifically, please refer to FIG. 7. In the second direction Y, the first contact hole C1 can be aligned with the second contact hole C2, and the first contact hole C1 can be partially overlapped with the second contact hole C2.

In the second direction Y, the sixth part P6 can be overlapped with the first contact hole C1 and the second contact hole C2, and the seventh part P7 can be overlapped with the first contact hole C1 and the second contact hole C2.

In this embodiment, a width W4 of the sixth part P6 and the seventh part P7 can be less than a width W3 of the fifth part P5, and the width W3 and the width W4 can be less than 10 micrometers and greater than 1 micrometer (i.e., 1 μm≤W4≤W3≤10 μm), thereby reducing the risk of a short circuit between the adjacent first branch 3211 and third branch 3221a (or between the adjacent second branch 3212 and third branch 3221a) due to being too close, but is not limited thereto. That is, the third branch 3221a comprises a portion (i.e., the fifth part P5) not overlapped with the first wire part 330 and another portion (i.e., the sixth part P6 and the seventh part P7) overlapped with the first wire part 330, and a width W4 of the another portion is less than a width W3 of the portion.

In this embodiment, a minimum distance D2 between the second part P2 and the sixth part P6 (or between the fourth part P4 and the sixth part P6) can be less than a minimum distance D1 between the first part P1 and the fifth part P5 (or between the third part P3 and the fifth part P5), and both the minimum distance D1 and the minimum distance D2 can be less than 5 micrometers and greater than 1 micrometer (i.e., 1 μm≤D2≤D1≤10 μm), to reduce a spacing between the adjacent first branch 3211 and third branch 3221a (or between the adjacent second branch 3212 and third branch 3221a), and reduce the risk of a short circuit caused by them being too close, but it is not limited thereto.

For example, in this embodiment, the maximum width W1 can be, for example, 4 micrometers, the maximum width W2 can be, for example, 8 micrometers, the width W3 can be, for example, 4 micrometers, the width W4 can be, for example, 2 micrometers, the minimum distance D1 can be, for example, 4 micrometers, and the minimum distance D2 can be, for example, 3 micrometers, but is not limited thereto.

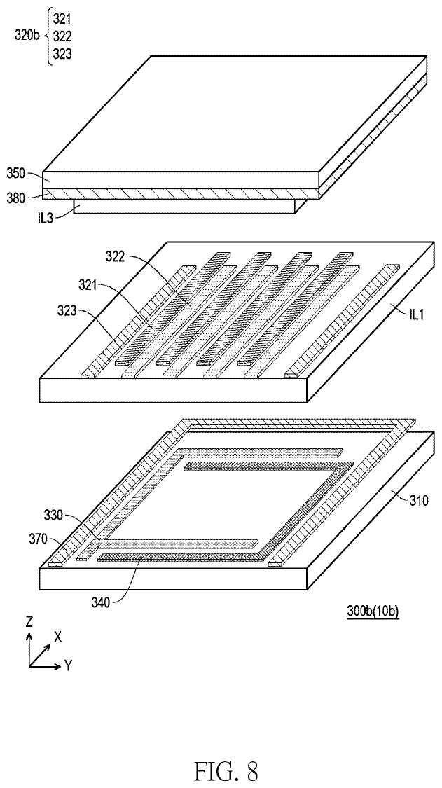

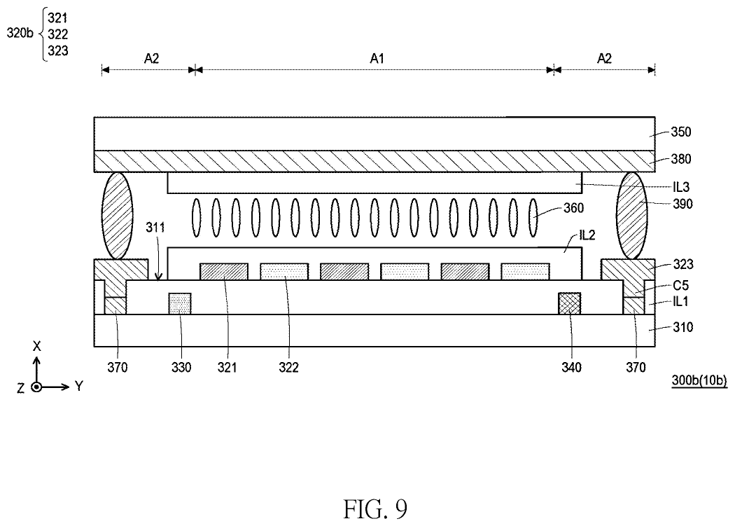

FIG. 8 is an exploded schematic view of an electronic device according to another embodiment of the present disclosure. FIG. 9 is a schematic cross-sectional view of the electronic device of FIG. 8. For clarity of the drawings and ease of description, FIG. 8 and FIG. 9 omit certain components from the electronic device 10 of FIG. 1 and FIG. 2 (for example: backlight module, optical module, dielectric layer, and display panel, etc.). Please refer to FIG. 1, FIG. 2, FIG. 8, and FIG. 9 simultaneously. The electronic device 10b of this embodiment is similar to the electronic device 10 of FIG. 1 and FIG. 2, with the difference being that: in the electronic device 10b of this embodiment, the switchable panel 300b further comprises a third wire part 370, a fifth contact hole C5, another electrode layer 380, and a connector 390, and the electrode layer 320b further comprises a third electrode part 323.

Specifically, please refer to FIG. 8 and FIG. 9. The third wire part 370 is disposed on the first surface 311 of the first substrate 310 and covered by the insulating layer IL1. The first wire part 330, the second wire part 340, and the third wire part 370 can be physically separated from one another. In some embodiments, the first wire part 330, the second wire part 340, and the third wire part 370 can be electrically separated from one another, and the first wire part 330, the second wire part 340, and the third wire part 370 transmit different signals. In this embodiment, the third wire part 370 is opaque, and the third wire part 370 may comprise metal or metal oxide, such as copper or other opaque conductive materials, but is not limited thereto.

The third electrode part 323 is disposed on the first surface 311 of the first substrate 310 and the insulating layer IL1. The third electrode part 323 is disposed in the second region A2. The first electrode part 321, the second electrode part 322, and the third electrode part 323 can be physically separated from one another. In some embodiments, the first electrode part 321, the second electrode part 322, and the third electrode part 323 can be electrically separated from one another, and the first electrode part 321, the second electrode part 322, and the third electrode part 323 transmit different signals. In some embodiments, a shape of the third electrode part 323 is the same as a shape of the third wire part 370, but is not limited thereto.

The fifth contact hole C5 can extend through the insulating layer IL1. Opposite sides of the fifth contact hole C5 can respectively contact the third electrode part 323 and the third wire part 370. That is, the third electrode part 323 can be electrically connected to the third wire part 370 via the fifth contact hole C5.

Another electrode layer 380 is disposed on the insulating layer IL3, and the another electrode layer 380 is disposed between the dielectric layer 360 and the second substrate 350.

The connector 390 is disposed on the first surface 311 of the first substrate 310, and the connector 390 is disposed between the third electrode part 323 and the another electrode layer 380. Opposite sides of the connector 390 can respectively contact the another electrode layer 380 and the third electrode part 323. That is, the another electrode layer 380 can be electrically connected to the third electrode part 323 via the connector 390. In this embodiment, the connector 390 can be a gold bump, but is not limited thereto.

In summary, in the electronic device according to an embodiment of the present disclosure, by disposing the wire parts (i.e., the first wire part and the second wire part) electrically connected to the electrode parts (i.e., the first electrode part and the second electrode part) in the second region, the impedance of the electrode parts in the first region can be reduced. By having the first contact hole misaligned with the second contact hole in the second direction, by having another portion of the third branch overlapped with the first wire part (i.e., the sixth part and the seventh part) have a curved shape, or by having a width of the another portion of the third branch overlapped with the first wire part be less than a width of the portion of the third branch not overlapped with the first wire part, the risk of a short circuit between the adjacent first branch and third branch (or between the adjacent second branch and third branch) due to being too close can be reduced.

Finally, it should be noted that: the above embodiments are only for illustrating the technical solutions of the present disclosure, not for limiting them; although the present disclosure has been described in detail with reference to the foregoing embodiments, persons of ordinary skill in the art should understand that: they can still modify the technical solutions described in the foregoing embodiments, or make equivalent replacements to some or all of the technical features therein; and these modifications or replacements do not cause the essence of the corresponding technical solutions to depart from the scope of the technical solutions of the embodiments of the present disclosure.

What is claimed is:

1. An electronic device, having a first region and a second region adjacent to the first region, the electronic device comprising:
a switchable panel, comprising:
a first substrate, wherein the second region is closer to an edge of the first substrate than the first region;
an electrode layer, disposed on a first surface of the first substrate and comprising a first electrode part and a second electrode part, wherein at least a portion of the first electrode part is disposed in the first region, and at least a portion of the second electrode part is disposed in the first region;
a first wire part, disposed in the second region and electrically connected to the first electrode part;
a second wire part, disposed in the second region and electrically connected to the second electrode part;
a second substrate, disposed opposite to the first surface of the first substrate; and
a dielectric layer, disposed between the electrode layer and the second substrate;
wherein the first electrode part comprises a first branch and a second branch extending along a first direction, and the second electrode part comprises a third branch and a fourth branch extending along the first direction.

2. The electronic device of claim 1, wherein the first branch is electrically connected to the first wire part via a first contact hole, the second branch is electrically connected to the first wire part via a second contact hole, and the third branch is electrically connected to the second wire part via a third contact hole.

3. The electronic device of claim 2, wherein the third branch comprises a portion not overlapped with the first wire part and another portion overlapped with the first wire part, and a width of the another portion is less than a width of the portion.

4. The electronic device of claim 2, wherein the first contact hole is aligned with the second contact hole in a second direction.

5. The electronic device of claim 2, wherein the first contact hole is misaligned with the second contact hole in a second direction.

6. The electronic device of claim 5, wherein the third branch comprises a portion not overlapped with the first wire part and another portion overlapped with the first wire part, and the another portion has a curved shape.

7. The electronic device of claim 1, further comprising:
a display panel, at least partially overlapped with the switchable panel.

8. The electronic device of claim 1, wherein the electrode layer is transparent.

9. The electronic device of claim 8, wherein the electrode layer comprises indium tin oxide.

10. The electronic device of claim 1, wherein a first voltage is applied to the first electrode part, a second voltage is applied to the second electrode part, and the first voltage is different from the second voltage.
